(19) United States
(12) Patent Application Publication
(10) Pub. No.: US 2013/0107576 A1
(43) Pub. Date: May 2, 2013

(54) LIGHT-GUIDE MEMBER, METHOD OF MAKING LIGHT-GUIDE MEMBER, AND PORTABLE ELECTRONIC DEVICE

(71) Applicant: ZHI YE, Shenzhen City (CN)

(72) Inventor: ZHI YE, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/400,858

(22) Filed: Feb. 21, 2012

(30) Foreign Application Priority Data
Oct. 31, 2011 (CN) 201110337326.X

(51) Int. Cl. F21V 8/00; G02B 6/00

(52) U.S. Cl. 362/621; 427/163.2; 264/1.24

(57) ABSTRACT

A light-guide member includes a transparent light-guide body, a reflective layer and a shading layer. The light-guide body includes a light incident surface, a light-emitting surface and a peripheral surface connecting the light incident surface and the light-emitting surface. The peripheral surface includes at least one reflective surface for transmitting the light entering form the light incident surface out of the light-emitting surface. The reflective layer may be painted on the reflective surface. The shading layer may be painted on the reflective layer.

### BACKGROUND

1. Technical Field

The disclosure generally relates to light-guide members and a method of making the light-guide members, and further to portable electronic devices incorporating light-guide members.

2. Description of the Related Art

Portable electronic devices (e.g. mobile phones) may include a housing, and a light member (e.g. LED) and a transparent light-guide pole mounted in the housing. The housing may define a transparent window opposite to the light member. However, the inside space of the housing is usually limited, making positioning of the light member relative to the transparent window difficult. Accordingly, the displacement of the light member from the transparent window in affects the illumination of the light member.

Therefore, there is room for improvement within the art.

### BRIEF DESCRIPTION OF THE DRAWINGS

Many aspects of the exemplary light-guide member, method of making the light-guide member and portable electronic device can be better understood with reference to the following drawings. The components in the various drawings are not necessarily drawn to scale, the emphasis instead being placed upon clearly illustrating the principles of the exemplary light-guide member, method of making the light-guide member and portable electronic device. Moreover, in the drawings, like reference numerals designate corresponding parts throughout the diagrams.

FIGS. 1 and 2 are isometric views of a light-guide member according to an exemplary embodiment.

FIG. 3 is a cross-sectional view of the light-guide member shown in FIG. 1, taken along a line III-III.

FIG. 4 is a cross-sectional view of an exemplary embodiment using the light-member shown in FIG. 1.

FIG. 6 is a cross-sectional view of a light-guide member according to another exemplary embodiment.

### DETAILED DESCRIPTION

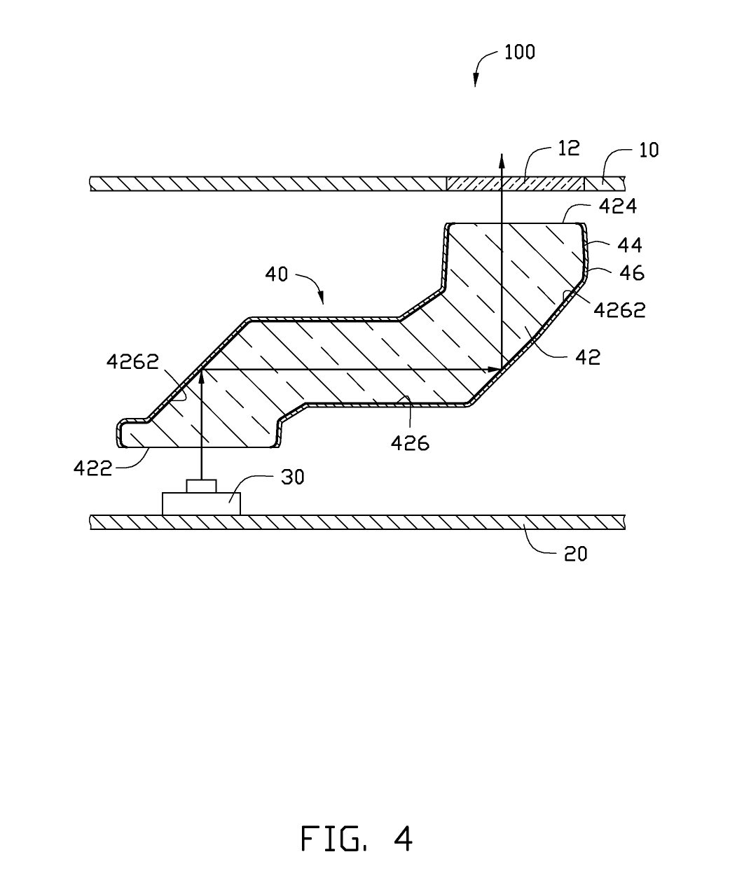

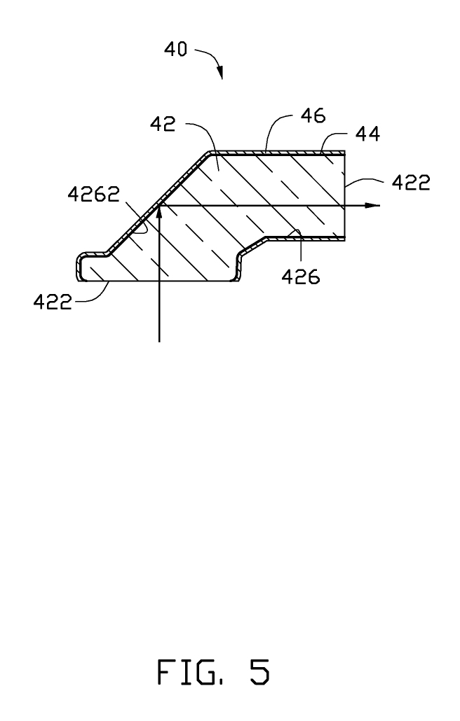

FIG. 4 shows an exemplary embodiment of a portable electronic device 100 including a housing 10, a main circuit board 20 mounted in the housing 10, a light member 30 fixed on the main circuit board 20 and a light-guide member 40 positioned between the housing 10 and the light member 30. The light-guide member 40 is fixed on the housing 10 for transmitting the light produced by the light member out of the housing 10. The housing 10 defines a transparent window 12. The light member 30 is electrically connected to the main circuit board 20.

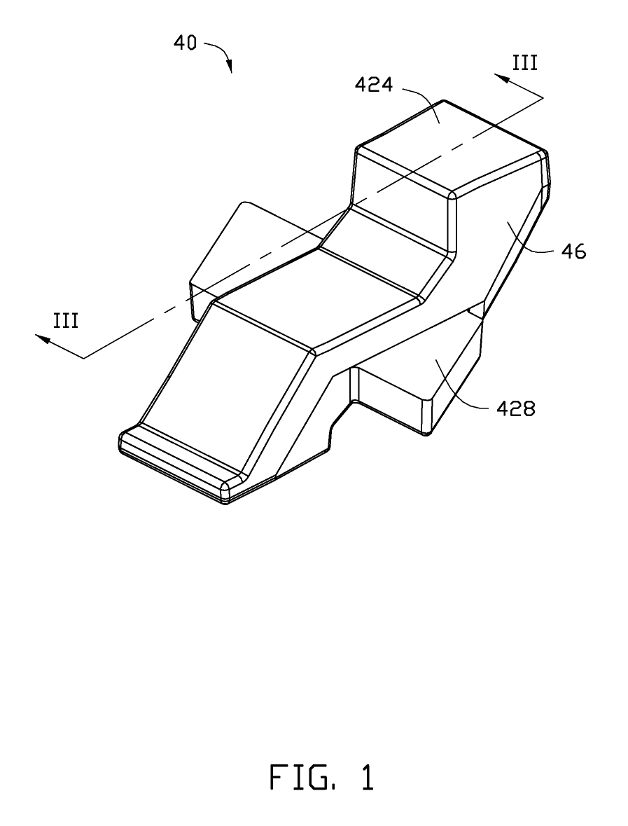

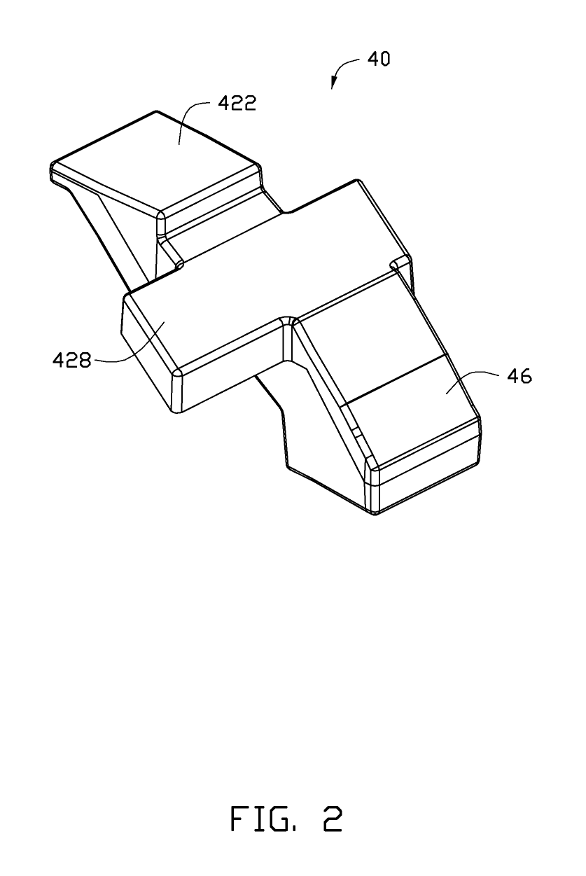

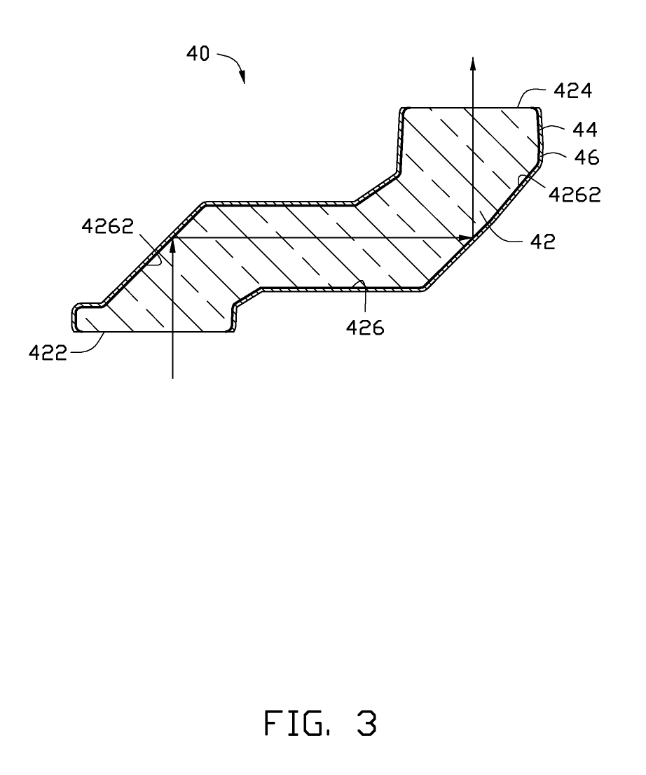

In FIGS. 1-3, the light-guide member 40 includes a light-guide body 42, a reflective layer 44 is formed on the light-guide body 42, such as by painting and a shading layer 46 is formed on the reflective layer 44, such as by painting.

The light-guide body 42 may be made of transparent thermosetting materials or semi-transparent thermosetting materials, being one or more selected from a group of polycarbonate, polymethyl methacrylate, acrylonitrile butadiene styrene, and polystyrene.

The light-guide body 42 includes a light incident surface 422 opposite to the light member 30, a light-emitting surface 424 opposite to the transparent window 12 and a peripheral surface 426 connecting the light incident surface 422 and the light-emitting surface 424. The peripheral surface 426 includes two parallel reflective surfaces 4262. One reflective surface 4262 is opposite to the light incident surface 422, the other reflective surface 4262 is opposite to the light-emitting surface 424.

The reflective layer 44 can be formed by painting on the peripheral surface 426 using reflective material to enable the reflective surface 4262 to be reflective. In this embodiment, the reflective material contains a silver component.

The shading layer 46 can be formed on the reflective layer 44 by using a painted on shading material to enforce the reflective ability of the reflective surface 4262. The shading material contains carbon component.

The light-guide 40 has fixing portions 428 projecting from the peripheral surface 426. The light-guide 40 is fixed to housing 10 using the fixing portions 428.

A method of making the light-guide member 40 may be implemented by an injection molding machine. The injection molding machine includes a molding chamber. Molten transparent or semi-transparent thermosetting material is injected into the molding chamber to mold the light-guide body 42.

When painting is used, a painting machine is provided. The painting machine includes a first spray module for spraying reflective material and a second spray module for spraying shading material. Double-faced adhesives cover the light incident surface 422 and the light-emitting surface 424. The light-guide body 42 is delivered through the first spray module to paint the reflective material and second spray module to paint the shading material in order. The double-faced adhesives are peeled off the light-guide body 42.

FIG. 5 is another exemplary embodiment of a light-guide member 40 including a reflective surface 4262 opposite to both of the light incident surface 422 and light-emitting surface 424.

It is to be understood, however, that even though numerous characteristics and advantages of the exemplary disclosure have been set forth in the foregoing description, together with details of the system and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A light-guide member, comprising:
a transparent light-guide body comprising a light incident surface, a light-emitting surface and a peripheral surface connecting the light incident surface and the light-emitting surface, the peripheral surface comprising at least one reflective surface for transmitting the light entering from the light incident surface out of the light-emitting surface;
a reflective layer painted on the reflective surface; and
a shading layer painted on the reflective layer.

2. The light-guide member as claimed in claim 1, wherein the reflective layer is a reflective material containing silver component.

3. The light-guide member as claimed in claim 1, wherein the shading layer is a shading material containing carbon component.

4. The light-guide member as claimed in claim 1, wherein the light-guide body is made by injection molding.

5. A portable electronic device comprising:
a housing defining a light-guide window;
a light member; and
a light-guide member comprising:
a transparent light-guide body comprising a light incident surface opposite to the light member, a light-emitting surface opposite to the light-guide window and a peripheral surface connecting the light incident surface and the light-emitting surface, the peripheral surface comprising at least one reflective surface for transmitting the light entering form the light incident surface out of the light-emitting surface;
a reflective layer formed on the reflective surface; and
a shading layer formed on the reflective layer.

6. The portable electronic device as claimed in claim 5, wherein the reflective layer comprises a reflective material containing silver component.

7. The portable electronic device as claimed in claim 5, wherein the shading layer comprises a shading material containing carbon component.

8. The portable electronic device as claimed in claim 5, wherein the light-guide body is made by injection molding.

9. The portable electronic device as claimed in claim 5, wherein the light-guide body has fixing portions projecting from the peripheral surface, the light-guide member is fixed on the housing with the fixing portions.

10. A method of making a light-guide member, comprising:
providing a transparent light-guide body comprising a light incident surface, a light-emitting surface and a peripheral surface connecting the light incident surface and the light-emitting surface, the peripheral surface comprising at least one reflective surface for transmit the light entering form the light incident surface out of the light-emitting surface;
painting the peripheral surface to cover a reflective layer on the reflective surface; and
painting the reflective layer to cover a shading layer on the reflective layer.

11. The method of making a light-guide member as claimed in claim 10, wherein light-guide body is made by injection molding.
